(19) United States
(12) Patent Application Publication
(10) Pub. No.: US 2024/0182250 A1
(43) Pub. Date: Jun. 6, 2024

(54) SORTING CONVEYOR SYSTEM

(71) Applicant: WIZART - ONLINE LTD, Tel Aviv-Yafo (IL)

(72) Inventor: Daniel FRIED, Yokneam Hamoshava (IL)

(73) Assignee: WIZART - ONLINE LTD, Tel Aviv-Yafo (IL)

(21) Appl. No.: 18/282,343

(22) PCT Filed: Mar. 14, 2022
(86) PCT No.: PCT/IL2022/050287

§ 371 Date: Sep. 15, 2023

(30) Foreign Application Priority Data
Mar. 17, 2021 (IL) 281611

(51) Int. Cl. B65G 47/46; B07C 3/08; B65G 47/76

(52) U.S. Cl. CPC B65G 47/46; B07C 3/08; B65G 47/766

(57) ABSTRACT

A sorting conveyor system comprising a primary conveyor extending along a conveying plane and configured with an item loading location and a plurality of unloading locations extending along the conveying plane, and at least one sorting bridge configured with an item sorting mechanism. The item sorting mechanism is configurable for displacing in four distinct orientations, wherein the first displacement orientation is associated with displacing the item sorting mechanism along the conveying plane. The second displacement orientation is associated with controlling passages of an item through the sorting bridge, the third displacement orientation is associated with controlled unloading of an item at an unloading location, the fourth displacement orientation is associated with controlling an impact angle of the item sorting mechanism with an item.

### TECHNOLOGICAL FIELD

The present disclosure is concerned with a multi-station sorting conveyor system.

### BACKGROUND ART

References considered to be relevant as background to the presently disclosed subject matter are listed below:
US20090078617
U.S. Pat. No. 10,633,189
DE102016124885

Acknowledgement of the above references herein is not to be inferred as meaning that these are in any way relevant to the patentability of the presently disclosed subject matter.

### BACKGROUND

US20090078617 is directed to a device for directionally guiding articles of different shapes that are being conveyed on a convey or off the conveyor with the aid of a movable gate that is controllable to move across the conveyor at an angle to the direction of travel of the article on the conveyor. The gate is made having a means which, upon movement across the conveyor, is designed to forcibly cause the article to be driven along the gate, in a direction corresponding to said angle, off the conveyor and to an exit. Advantageously, the means consists of at least one motor-driven, rotatable disc.

U.S. Pat. No. 10,633,189 described is a sorting machine comprising: a plurality of carriages, each carriage comprising a loading-unloading device which can be selectively activated for loading-unloading an object from the carriage and an electronic unit configured to receive and analyze a loading-unloading signal and actuate the loading-unloading device as a function of an operating mode, selected from a plurality of operating modes and uniquely associated with the loading-unloading signal: a plurality of loading stations and a plurality of unloading stations positioned along a sorting direction (X) comprising respective actuating units configured to generate the loading-unloading signal. Each carriage comprises a permanent magnet which generates a stationary magnetic field and each actuating unit comprises a Hall effect transducer configured to detect the presence of the stationary magnetic field generated by the permanent magnet.

DE102016124885 discloses a sorting device for sorting discrete products of a product stream comprising a wafer having at least one recess in the circumferential direction and a blocking portion adjacent thereto, wherein optionally the at least one recess or a blocking portion into the pathway of the product stream may move to the further promotion of products in conveying direction is permitted or prevented.

### General Description

The present disclosure is concerned with a sorting conveyor system, for sorting items placed thereon into discrete collecting stations, wherein the sorting conveyor system is configured with at least four digress of freedom.

The term ‘four degrees of freedom’ denotes a sorting arrangement configurable for moveable in four distinct orientations.

The term ‘item’ denotes any type of item, such as unitary items, e.g. groceries, consumer goods, articles of manufacture, and the like. However, this term refers also to a pack of unitary items (e.g. a pack of bottles, containers, etc.).

According to an aspect of the disclosure there is a sorting conveyor system comprising a primary conveyor extending along a conveying plane and configured with an item loading location; and a plurality of unloading locations extending along the conveying plane: and at least one sorting bridge configured with an item sorting mechanism;
said item sorting mechanism is configurable for displacing in four distinct orientations;
wherein the first displacement orientation is associated with displacing the item sorting mechanism along the conveying plane;
the second displacement orientation is associated with controlling passages of an item through the sorting bridge;
the third displacement orientation is associated with controlled unloading of an item at an unloading location; and
the fourth displacement orientation is associated with controlling an impact angle of the item sorting mechanism with an item.

The four distinct orientations namely are a first orientation along said conveying plane; a second orientation, normal with said conveying plane, for controlling passages of an item through a sorting bridge; a third orientation for deflecting an item to either a right unloading station or a left unloading station at an unloading location: and a fourth orientation for pivoting the item sorting mechanism about a second axis, normal with said conveying plane.

The term ‘conveyor’, as used herein the specification and claims, denote any form of conveying system used for conveying articles along a conveying path, such as, a conveyor belt, roller conveyors, chain conveyors, slat conveyors, etc.

The present disclosure is directed to a sorting conveyor system comprising a primary conveyor belt extending along a conveying plane and configured with an item loading location; a plurality of unloading locations extending along the conveying plane, each configurable with a right unloading station and a left unloading station; and at least one sorting bridge configured with an item deflecting mechanism;
wherein the at least one sorting bridge is configurable for axial displacement along a first axis, parallel with a conveying axis of the conveying plane;
and wherein the item deflecting mechanism is configured with at least three degrees of freedom, comprising of: axial displacement along a second axis, normal with said conveying plane; and pivotal displacement about the second axis; and an item displacing motion in a direction substantially traversing the first axis.

According to the present disclosure there is a sorting conveyor system comprising a primary conveyor belt extending along a conveying plane and configured with an item loading location: a plurality of unloading locations extending along the conveying plane, each configurable with a right unloading station and a left unloading station, each unloading location allocated with a distinct unloading location address, and each unloading station allocated with a distinct unloading address; and at least one sorting bridge configured with an item deflecting mechanism;
wherein the at least one sorting bridge is configurable for axial displacement along a first axis, parallel with a conveying axis of the conveying plane;
and wherein the item deflecting mechanism is configured with at least three degrees of freedom, comprising of: axial displacement along a second axis, normal to said conveying plane; and pivotal displacement about the second axis, and an item displacing motion for generating a reaction in either a right side orientation or a left side orientation.

According to a specific configuration the item deflecting mechanism is a linear belt-driven transfer mechanism configured for traveling in a back and forth direction, corresponding with a respective right left unloading station and a left unloading station of an unloading location.

The linear belt-driven transfer mechanism can be configured with at least a pair of substantially vertically disposed pullies, defining therebetween a deflecting plane, wherein said deflecting plane extends normal with the conveying plane.

The arrangement is such that the deflecting plane is configurable for pivoting about the second axis, so as to extend inclined with respect to the first axis:

The item deflecting mechanism can be configured for axial displacement along the first axis, parallel with a conveying axis of the conveying plane, together with the sorting bridge or respective to the sorting bridge.

The item deflecting mechanism can be for displacing an item to from the conveyor plane to left and right locations, while the primary conveyor is in motion.

The sorting conveyor system can further comprise a controller and an item recognition system, disposed at the item loading location and configurable for recognizing and identifying items placed at the item loading location, whereby the controller generates a destination address, in register with an order address, being a right unloading station or a left unloading station of an unloading location, followed by a series of control signals to the at least one sorting bridge, so as to displace an identified item to an allocated destination address.

The arrangement is such that an item placed at the item loading location is recognized by the item recognition system and is allocated a destination address being a right unloading station or a left unloading station of an unloading location, whereby the primary conveyor belt displaces the item towards the unloading location, wherein the item deflecting mechanism deflects the item to the destination address.

At the event that a destination address of an item is at a location behind a first sorting bridge of the sorting conveyor system, then the item deflecting mechanism of said first sorting bridge displaces upwards, along the second axis, so as to facilitate passage of the item along with the primary conveyor belt, towards an allocated unloading location.

The right unloading station and left unloading station of the unloading locations can be configured with a secondary conveying system extending from the primary conveyor belt towards an item collecting location.

Any one of the following features, designs and configurations can be applied to any aspect of the present disclosure, solely or in various combinations thereof:
Identification of the items can take place at the item loading location of the primary conveyor, or it can take place at an identifying conveyor disposed prior to the primary conveyor and configured for cooperating in conjunction therewith: wherein items from the identifying conveyor proceed spontaneously to the primary conveyor;
Each unloading location can be associated with a sorting bridge;
The secondary conveying system can be an endless conveyor or a roller system;
Pivoting the item deflecting mechanism about the second axis can be useful for example at the event of a conical, spheric or round item approaching the secondary conveying system
The item recognition system can be one or more of an item recognition unit, image recognition system, weight related recognition system, an item code reading system, LIDAR system, etc.;
A loading conveyor can be disposed before the primary conveyor belt, said loading conveyor configurable with the item deflecting mechanism, and wherein items from the loading conveyor autonomously displace onwards to the primary conveyor belt;
Any one or more displacement motions can be speed-controlled, acceleration controlled, location controlled, weight/force controlled, etc.;
Each of the four distinct degrees of freedom can be governed by an individual motor;
Each of the individual motors can be configured with a sensor for generating one or more of a position indicative signal, a vector/direction indicative signal, a speed indicative signal, a load indicative signal, etc.;
The sorting conveyor can be configured with one or more item sensors for determining proximity and position of an item approaching an item deflecting mechanism of a respective sorting bridge;
The sorting bridge can be configured for sorting items at one or more unloading locations;
The sorting bride can be configured with a gapping conveyor portion extendable over a gap between the primary conveyor belt and a secondary conveying system extending from the primary conveyor belt towards an item collecting location;
The gapping conveyor portion can be a set of rollers;
The gapping conveyor portion can be coplanar with the primary conveyor belt;
The item deflecting mechanism can span at least the width of the primary conveyor belt; the second axis can extend at a right angle (perpendicular) with respect to the conveying plane.

### BRIEF DESCRIPTION OF THE DRAWINGS

In order to better understand the subject matter that is disclosed herein and to exemplify how it may be carried out in practice, an embodiment will now be described, by way of non-limiting example only, with reference to the accompanying drawings, in which:

FIG. 1 is a perspective view of a sorting conveying system according to an example of the disclosure, configured with an identifying conveyor loaded with items to be sorted;

FIG. 2 illustrates the conveyor system of FIG. 1, however with item collecting locations removed:

FIG. 3 is a perspective view of a sorting bridge used in a conveyor system, according to an example of the disclosure:

FIG. 4A is a section along line IV-IV in FIG. 1;

FIG. 4B is the same as FIG. 4A with item collecting locations removed; and

FIGS. 5A and 5B illustrate the sorting conveyor system of FIG. 1 at consecutive sorting stages, however with item collecting locations removed.

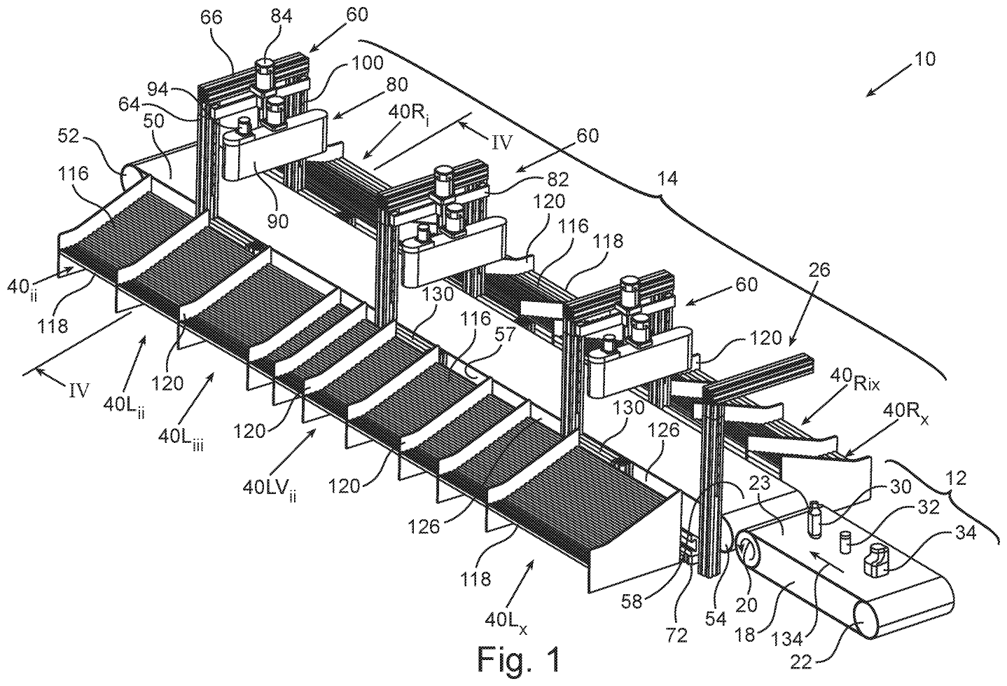

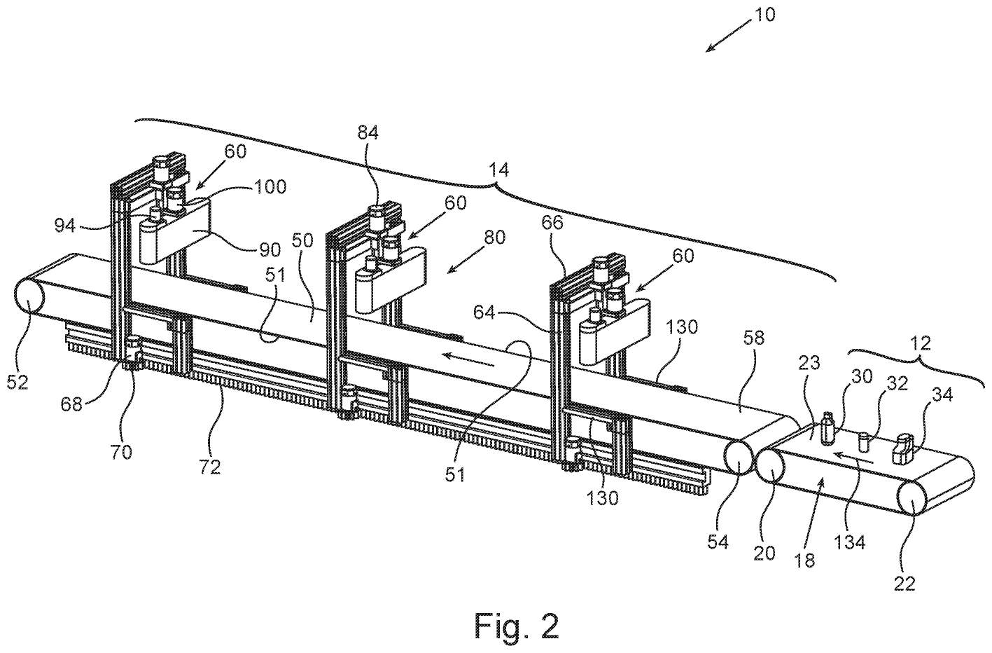

### DETAILED DESCRIPTION OF EMBODIMENTS

With reference to the annexed drawings there is illustrated a sorting conveyor system according to an example of the disclosure, generally designated 10.

The conveyor system 10 comprises an identifying conveyor portion 12 and a sorting conveyor portion 14, wherein the identifying conveyor portion 12 comprises an endless conveyor belt 18 tensioned over a head pully 20 and a tail pully 22, with an item recognition system 26 disposed in proximity to conveyor belt 18.

Item recognition system 26 comprises an identification bridge 28 configured with an optical identification system (not seen) disposed over conveyor belt 18 and being in communication with a controller of the system (not seen), wherein the identification system item recognition system can be one or more of an image recognition system, an item code reading system, etc., configured for identifying items placed on the conveyor belt 18 as they pass under the identification bridge 28.

As will be discussed hereinafter, items that have been identified and recognized by the item recognition system 26 are allocated a destination address, namely one of a plurality of unique unloading stations 40_{Ri} to 40_{Rx} disposed at a right side of the sorting conveyor portion 14, and a plurality of unique unloading stations 40_{Li} to 40_{Lx} disposed at a left side of the sorting conveyor portion 14. Each of the unique unloading stations is a destination of the sorted items, as per a pre-loaded list generated by the controller.

The sorting conveyor portion 14 comprises an endless primary conveyor belt 50 defining a conveying plane and being tensioned over a head pully 52 and a tail pully 54, with several idlers and support beds (not shown), with an item loading location disposed 58 disposed in close proximity to a downstream portion 23 of the sorting conveyor 18, the arrangement being such that items placed over the sorting conveyor 18 spontaneously transfer over to a primary conveyor belt 50 of the sorting conveyor portion 14, without delay and without having to slow the process.

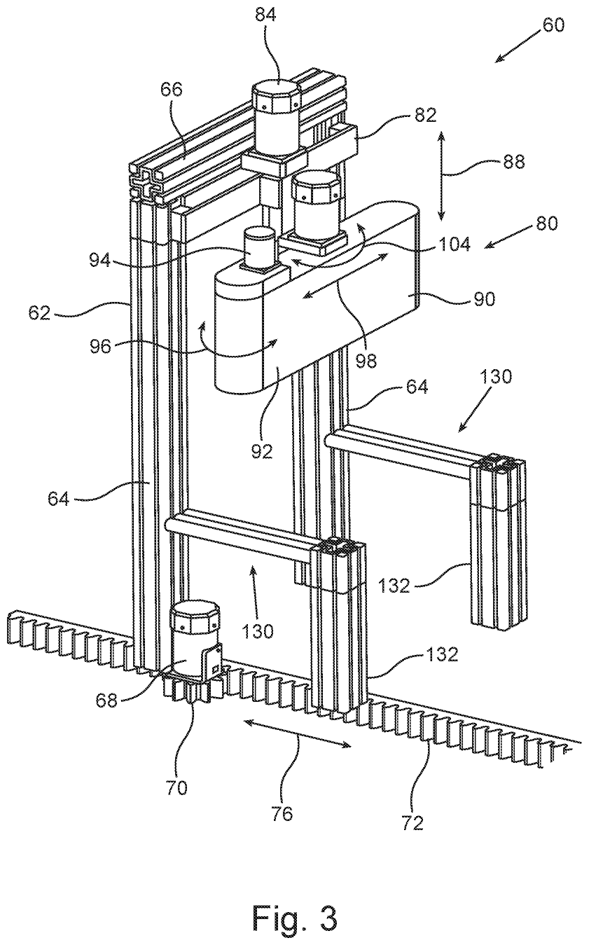

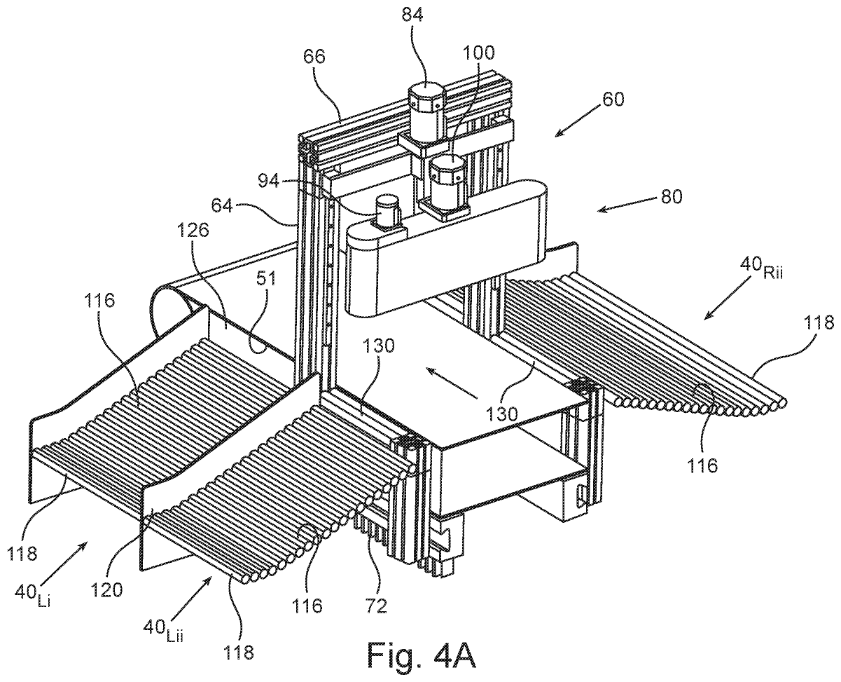

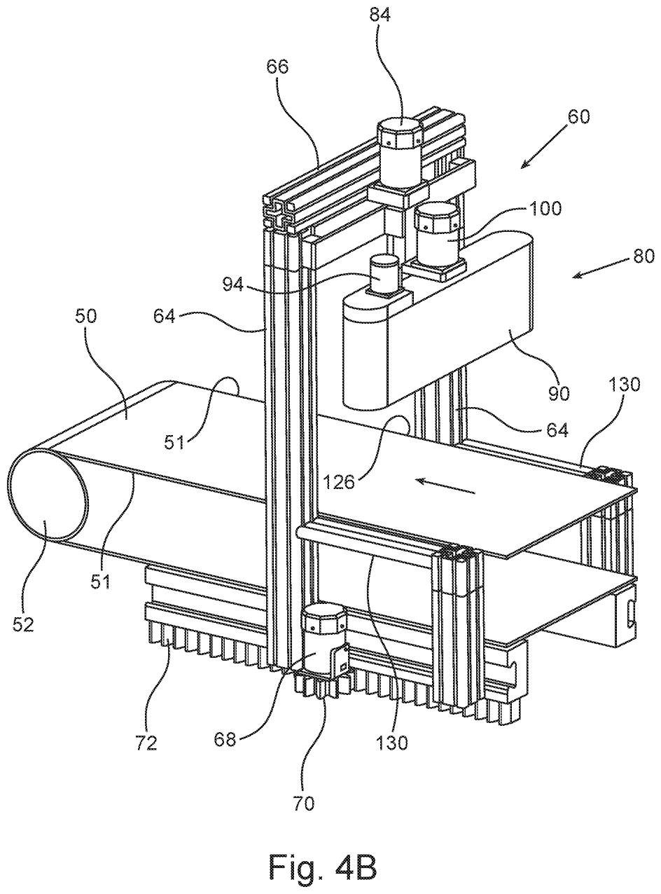

The sorting conveyor portion 14 is further configured with a plurality (three in the illustrated example) of sorting bridges generally designated 60, best seen in isolated view in FIG. 3 of the drawings. A sorting bridge 60 comprises a rigid support frame 62 with a pair of upright support legs 64 and a head portion 66 therebetween, wherein an electric motor 68 (e.g. a step motor) is articulated at the bottom of one of the support legs 64, said motor configured with a pinion gear engaged for rotation over a rack gear 72, for imparting the sorting bridge 60 linear (axial) displacement along the primary conveyor belt 50, i.e. back and forth displacement along double headed arrow 76, namely at a first orientation (first axis) along said conveying plane (defined by the primary conveying belt 50).

The sorting bridge 60 is further configured with an item deflecting mechanism generally designated 80, secured to a bar 82 articulated to the support legs 64 and configured for vertically displacement along said support legs 64 by a step motor 84, wherein displacement takes place along a second axis, normal to said conveying plane, in up/down direction as per double headed arrow 88.

The sorting bridge 60 further comprises linear belt-driven transfer mechanism 90, comprising an endless belt 92 tensioned over a set of pullies (not seen), one of which driven by an electric step motor 94 rotatable in both directions (arrow 96), for imparting an item with linear displacing motion in direction of double headed arrow 98, for generating a reaction in either a right-side orientation or a left side orientation, as will be clarified hereinafter.

In addition, the sorting bridge 60 is constructed such that the item deflecting mechanism is articulated to an electric step motor 100 for pivotal displacement of the item deflecting mechanism about the second axis 88, as per double headed arrow 104, whereby the item deflecting endless belt 92 is pivotal to assume an obtuse angle with the respect to the first axis, for directing an item to a respective right or left unloading station, as will be discussed herein after.

The arrangement is such that the item deflecting mechanism is configured with four degrees of freedom, comprising of:
linear reciprocal axial displacement along the first axis (in the plane of the primary conveyor belt), imparted by the pinion and rack gear system and operated by motor 68;
linear axial reciprocal displacement along the second axis 88, normal with said conveying plane (substantially vertically), imparted by bar 82 displaceable over support legs 64 and operated by motor 84;
an item displacing motion, in a direction substantially traversing the first axis, namely left or right rotation of the belt 92 by motor 94; and
pivotal reciprocal displacement of the linear belt-driven transfer mechanism 90, about the second axis, by motor 100.

It is appreciated that each of the motors 68, 84, 94 and 100, as well as motors associated with rotation of the conveyor pulleys (not shown) are in communication with the controller of the system and further, wherein the sorting conveyor system 10 is configured with a plurality of sensors (not shown) for generating one or more of a position indicative signal, a vector/direction indicative signal, a speed indicative signal, a load indicative signal, item oriented sensors, etc. it is appreciated that each of the plurality of sorting bridges 60 is independent of the other sorting bridges and further wherein the motion in the degrees of freedom of a particular sorting bridge are independently manipulable and can take place simultaneously.

As previously explained, the sorting bridges 60 are linearly displaceable, back and forth along the first axis, parallel to the conveying plane of conveyor belt 50, wherein a sorting bridge 60 is allocated to serve several unique unloading stations, through according to other examples (not shown), a sorting bridge can be associated with each unloading station.

Further noted, the unloading stations are in communication with the primary conveyor belt 50 by independent inclined roller conveyors 116, extending from said primary conveyor belt 50 to an unloading end 118 and wherein the unique unloading stations 40_{Ri} to 40_{Rx} and unique unloading stations 40_{Li} to 40_{Lx} disposed at respective right and left sides of the sorting conveyor portion 14, are partitioned by partition walls 120. However, due to axial displacement of the sorting bridges 60 along the primary conveyor belt 50, there is a gap 126 extending between a top edge of the roller conveyors 116 and a side edge 51 of the primary conveyor belt 50. Thus, each sorting bridge 60 is configured with a set of free rollers 130 disposed between upright support legs 64 and a support arm 132, said free rollers 130 being substantially coplanar with the primary conveyor belt 50, thus configured for bridging the gap 126, whereby items can smoothly displace from the primary conveyor belt 50 on to the inclined roller conveyors 116.

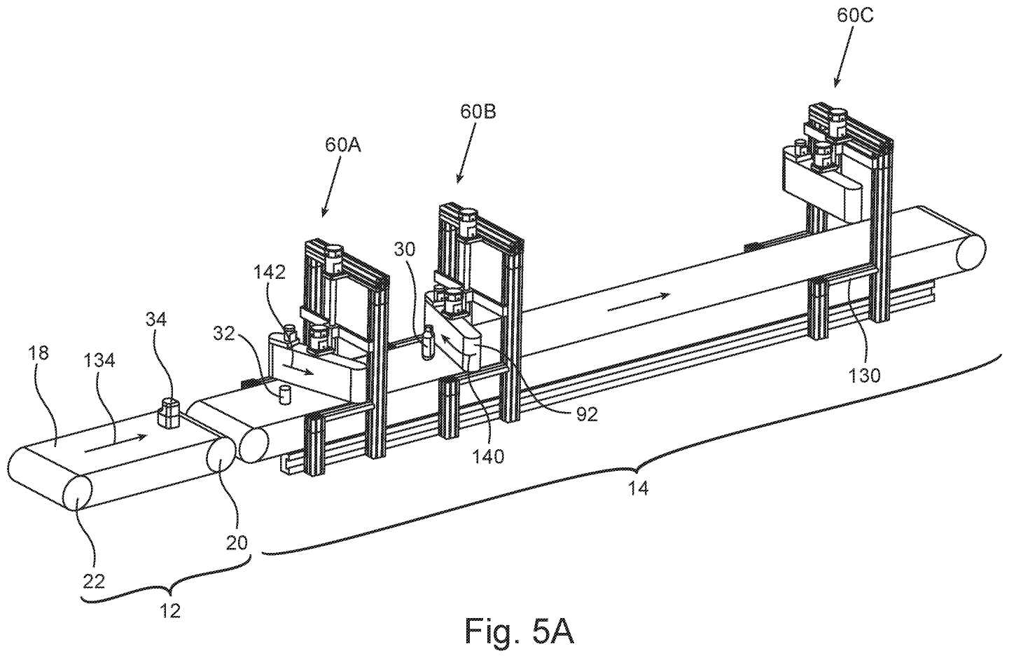

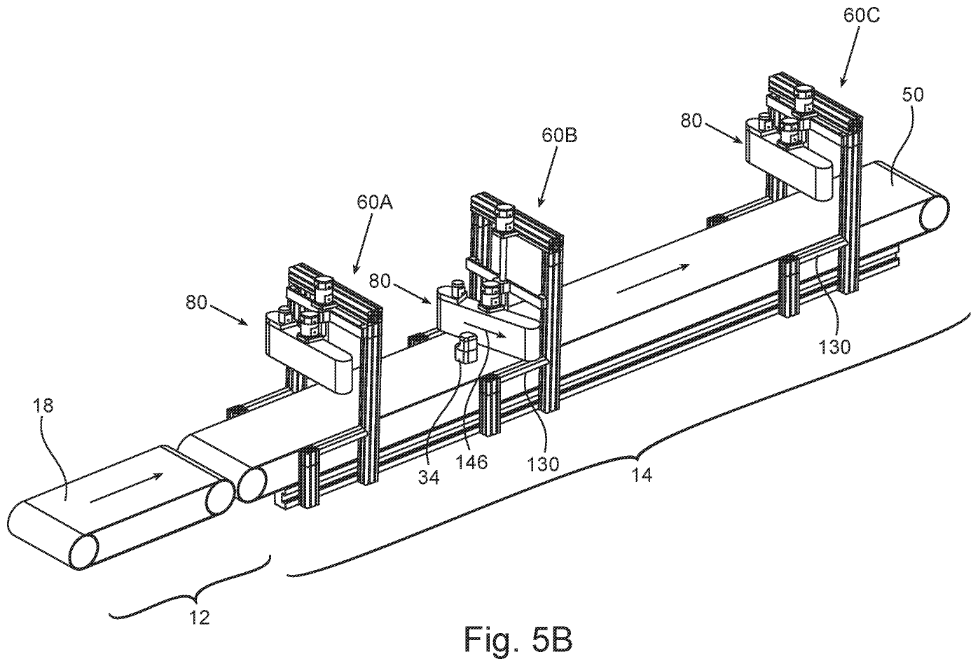

In use, a plurality of items (e.g., bottle 30, can 32 and container 34) are placed on the conveyor belt 18 of the identifying conveyor portion 12. As the conveyor belt 18 revolves, the items progress in direction of arrow 134 towards the identification bridge 28, wherein each item is identified and allocated, on the go, by the controller with a destination address, i.e., one of a plurality of unique unloading stations 40_{Ri} to 40_{Rx} and 40_{Li} to 40_{Lx}. As the conveyor belt 18 continues to move, the items displace on to the primary conveyor belt 50. Now, assuming a certain item is allocated a downstream unloading station (say unloading station 40_{Lvii} extending behind the first bridge 60A; FIGS. 5A and 5B), then said first bridge 60A is manipulated such that the item deflecting mechanism 80 moves to its uppermost position (FIG. 5B) facilitating moving of said item along the primary conveyor belt 50 towards the next bridge 60B. Likewise, id said item is allocated an unloading station associated with the last bridge 60C, then the second bridge 60B is also manipulated such that item deflecting mechanism 80 moves to its uppermost position, to facilitate moving of said item along the primary conveyor belt 50 towards the next bridge 60C.

Now, when a specific item is allocated a designated left unloading station, then an item deflecting mechanism 80 of a respective bridge 60 is disposed at its lowermost position (whereat a bottom edge of the endless belt 92 is adjacent a top surface of the primary conveyor belt 50) and said item deflecting mechanism 80 pivots about the second axis towards the respective side. For example, in FIG. 5A the second bridge 60B is at its lowermost position, with the item deflecting mechanism 80 pivoted to the left, with belt 92 rotating in direction of arrow 140, whereby as bottle 30 engages the belt 92 it will displace to a left side unloading station. However, when a specific item is allocated a designated right unloading station, then an item deflecting mechanism 80 of a respective bridge 60 is disposed at its lowermost position and said item deflecting mechanism 80 pivots about the second axis towards the right side. For example, in FIG. 5A the first bridge 60A is at its lowermost position, with the item deflecting mechanism 80 pivoted to the right, with belt 92 rotating in direction of arrow 142, whereby as bottle can 32 engages the belt 92 it will displace to a right-side unloading station (not shown).

In FIG. 5B the first bridge 60A is at its uppermost position, such that the container 34 moves onwards towards the second bridge 60B, the later disposed at its lowermost position, and pivoted to the right, and with the belt rotating in direction of arrow 146, whereby the container 34 is deflected towards a right unloading station (not shown).

1. A sorting conveyor system comprising a primary conveyor extending along a conveying plane and configured with an item loading location; and a plurality of unloading locations extending along the conveying plane; and at least one sorting bridge configured with an item sorting mechanism;
said item sorting mechanism is configurable for displacing in four distinct orientations; wherein the first displacement orientation is associated with displacing the item sorting mechanism along the conveying plane;
the second displacement orientation is associated with controlling passages of an item through the sorting bridge;
the third displacement orientation is associated with controlled unloading of an item at an unloading location; and
the fourth displacement orientation is associated with controlling an impact angle of the item sorting mechanism with an item.

2. The conveyor system according to claim 1, wherein the four distinct orientations namely are a first orientation along said conveying plane in along first axis; a second orientation, normal with said conveying plane, for controlling passages of an item through a sorting bridge; a third orientation for deflecting an item to either a right unloading station or a left unloading station at an unloading location; and a fourth orientation for pivoting the item sorting mechanism about a second axis, normal with said conveying plane.

3. The conveyor system according to claim 1, wherein the item deflecting mechanism is a linear belt-driven transfer mechanism configured for traveling in a back and forth direction, corresponding with a respective right left unloading station and a left unloading station of an unloading location.

4. The conveyor system according to claim 1, wherein a linear belt-driven transfer mechanism is configured with at least a pair of substantially vertically disposed pullies, defining therebetween a deflecting plane, wherein said deflecting plane extends normal with the conveying plane.

5. The conveyor system according to claim 4, wherein the deflecting plane is configurable for pivoting about a second axis, so as to extend inclined with respect to the first axis.

6. The conveyor system according to claim 1, wherein the item deflecting mechanism is configured for axial displacement along the first axis, parallel with a conveying axis of the conveying plane, together with the sorting bridge or respective to the sorting bridge.

7. The conveyor system according to claim 1, wherein the sorting conveyor system further comprises a controller and an item recognition system, disposed at the item loading location and configurable for recognizing and identifying items placed at the item loading location, whereby the controller generates a destination address, in register with an order address, being a right unloading station or a left unloading station of an unloading location, followed by a series of control signals to the at least one sorting bridge, so as to displace an identified item to an allocated destination address.

8. The conveyor system according to claim 1, wherein an item placed at the item loading location is recognized by the item recognition system and is allocated a destination address being a right unloading station or a left unloading station of an unloading location, whereby the primary conveyor belt displaces the item towards the unloading location, wherein the item deflecting mechanism deflects the item to the destination address.

9. The conveyor system according to claim 8, wherein at the event that a destination address of an item is at a location behind a first sorting bridge of the sorting conveyor system, then the item deflecting mechanism of said first sorting bridge displaces upwards, along the second axis, so as to facilitate passage of the item along with the primary conveyor belt, towards an allocated unloading location.

10. The conveyor system according to claim 1, wherein the right unloading station and left unloading station of the unloading locations are configured with a secondary conveying system extending from the primary conveyor belt towards an item collecting location.

11. The conveyor system according to claim 1, wherein the identification of the items takes place at the item loading location of the primary conveyor, or it can take place at an identifying conveyor disposed prior to the primary conveyor and configured for cooperating in conjunction therewith; wherein items from the identifying conveyor proceed spontaneously to the primary conveyor.

12. The conveyor system according to claim 10, wherein the secondary conveying system is an endless conveyor or a roller system.

13. The conveyor system according to claim 1, wherein a loading conveyor is disposed before the primary conveyor belt, said loading conveyor configurable with the item deflecting mechanism, and wherein items from the loading conveyor autonomously displace onwards to the primary conveyor belt.

14. The conveyor system according to claim 1, wherein each of the four distinct degrees of freedom is governed by an individual motor.

15. The conveyor system according to claim 14, wherein each of the individual motors is configured with a sensor for generating one or more control signals.

16. The conveyor system according to claim 1, wherein the sorting conveyor is configured with one or more item sensors for determining proximity and position of an item approaching an item deflecting mechanism of a respective sorting bridge.

17. The conveyor system according to claim 1, wherein the sorting bridge is configured for sorting items at one or more unloading locations.

18. The conveyor system according to claim 1, wherein the sorting bridge is configured with a gapping conveyor portion extendable over a gap between the primary conveyor belt and a secondary conveying system extending from the primary conveyor belt towards an item collecting location.

19. The conveyor system according to claim 18, wherein the gapping conveyor portion is a set of rollers.

20. The conveyor system according to claim 18, wherein the gapping conveyor portion is coplanar with the primary conveyor belt.

21. The conveyor system according to claim 1, wherein the item deflecting mechanism spans at least the width of the primary conveyor belt.

22. The conveyor system according to claim 2, wherein the second axis extends at a right angle with respect to the conveying plane.

23. A sorting conveyor system comprising a primary conveyor belt extending along a conveying plane and configured with an item loading location; a plurality of unloading locations extending along the conveying plane, each configurable with a right unloading station and a left unloading station; and at least one sorting bridge configured with an item deflecting mechanism;
wherein the at least one sorting bridge is configurable for axial displacement along a first axis, parallel with a conveying axis of the conveying plane;
and wherein the item deflecting mechanism is configured with at least three degrees of freedom, comprising of: axial displacement along a second axis, normal with said conveying plane; and pivotal displacement about the second axis; and an item displacing motion in a direction substantially traversing the first axis.

24. A sorting conveyor system comprising a primary conveyor belt extending along a conveying plane and configured with an item loading location; a plurality of unloading locations extending along the conveying plane, each configurable with a right unloading station and a left unloading station, each unloading location allocated with a distinct unloading location address and each unloading station allocated with a distinct unloading address; and at least one sorting bridge configured with an item deflecting mechanism;
wherein the at least one sorting bridge is configurable for axial displacement along a first axis, parallel with a conveying axis of the conveying plane;
and wherein the item deflecting mechanism is configured with at least three degrees of freedom, comprising of: axial displacement along a second axis, normal to said conveying plane; and pivotal displacement about the second axis, and an item displacing motion for generating a reaction in either a right-side orientation or a left side orientation.
